(19) United States
(12) Patent Application Publication
(10) Pub. No.: US 2020/0133110 A1
(43) Pub. Date: Apr. 30, 2020

(54) MULTIUSER PARALLAX DISPLAY WINDSHIELD

(71) Applicant: Continental Automotive Systems, Inc., Auburn Hills, MI (US)

(72) Inventor: David Arturo Fabila, Zapopan (MX)

(21) Appl. No.: 16/175,079

(22) Filed: Oct. 30, 2018

(51) Int. Cl. G03B 21/602; H04N 9/31

(52) U.S. Cl. CPC G03B 21/602; H04N 9/31

(57) ABSTRACT

A parallax barrier, laterally separated from the interior side of the windshield by a predetermined distance, allows the vehicle driver to have an unobstructed view through the vehicle windshield while simultaneously allowing the passenger to see images projected onto the same windshield by a projector device.

### BACKGROUND

A parallax barrier is a device that can be placed in front of an image source, such as a liquid crystal display or windshield, to allow the image source to show a stereoscopic or multiscopic image without the need for the viewer to wear 3D glasses. A parallax barrier comprises an opaque layer with a series of precisely spaced narrow slits. The slits allow each eye to see a different set of pixels creating a sense of depth through parallax in an effect similar to what lenticular printing produces for printed products and lenticular lenses for other displays.

One disadvantage of a parallax display barrier is that in its simplest form a viewer must be positioned in a well-defined spot to experience the 3D effect. However, recent versions of this technology have addressed this issue by using face-tracking to adjust the relative positions of the pixels and barrier slits according to the location of the user's eyes, allowing the user to experience the 3D from a wide range of positions. Another disadvantage is that the horizontal pixel count viewable by each eye is halved, reducing the overall horizontal resolution of the image.

An apparatus for allowing a drive and passenger to “see” different images through a vehicle windshield using the 3D display characteristics of a a parallax display barrier, would be an improvement over the prior art.

### BRIEF DESCRIPTION OF THE FIGURES

FIG. 1 schematically depicts top view of a multiuser parallax display windshield;

FIG. 2 depicts the view of the road in front of the vehicle as seen by the driver;

FIG. 3 shows images that the passenger sees projected onto the windshield from a projection device; and

FIG. 4 shows a top view of a curved windshield and top view of a curved parallax barrier.

### DETAILED DESCRIPTION

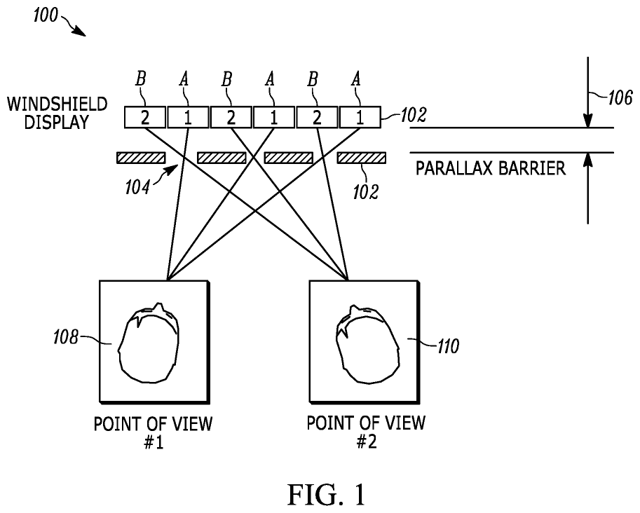

FIG. 1 schematically depicts the top view of a multiuser parallax display windshield 100. The parallax display windshield 100 includes an actual glass windshield 102 of course but it also includes a parallax barrier 104. As described above, a parallax barrier is a device placed in front of an image source that comprises an opaque layer with a series of precisely spaced narrow slits 104. The width of each slit 104 and its separation distance 106 from the windshield 102 are of course design choices, selected to provide to the driver 108 the ability to see objects in front of the motor vehicle but prohibiting the driver 108 from seeing an image projected on the same windshield by a display device.

In FIG. 1, the driver 108 sees only the portions of the image coming through the windshield (i.e., pixels) that are identified by reference letter “A.” The passenger on the other hand sees only the pixels identified by “B.” The driver and passenger thus see different images on the inside surface of the windshield 102. The driver 108 has an unobstructed view of what's in front of the vehicle. The passenger 110 sees images projected onto the windshield by a projection device.

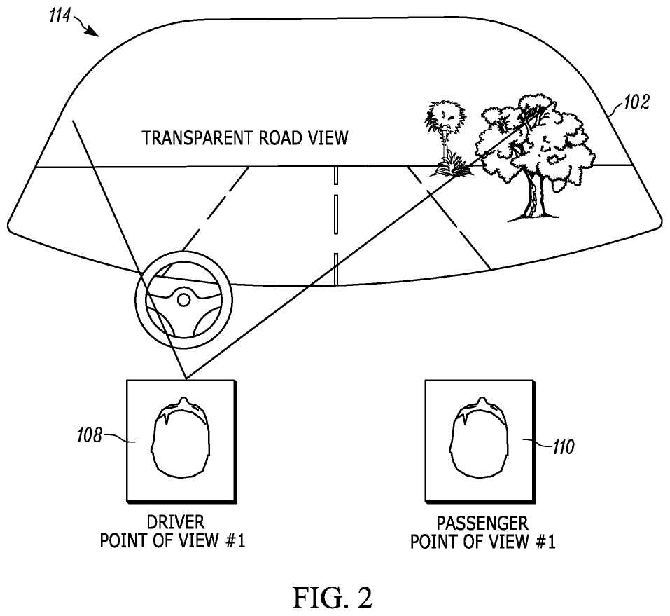

FIG. 2 depicts the view of the road in front of the vehicle as seen by the driver 108 through the parallax barrier 104. FIG. 2 thus shows a pictorial representation of a road view 114 through the vehicle windshield 102, with the vehicle windshield 102 “fronted” by the parallax barrier 102 depicted in FIG. 1. The passenger 110, however, does not see objects in front of the vehicle but instead sees images projected onto the windshield 102 by a display device 117.

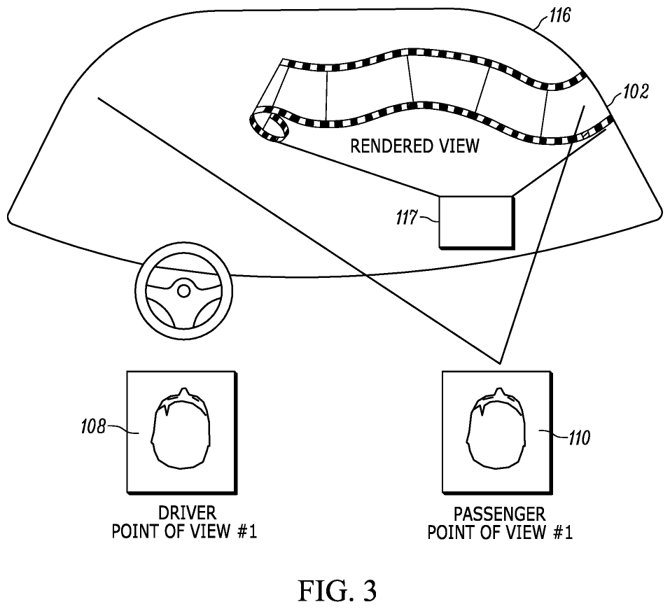

FIG. 3 shows images that the passenger 110 sees the series of images 116 projected onto the windshield 102 by the display device 117. The driver 108, however, does not see those same images but instead sees the road in front of the vehicle.

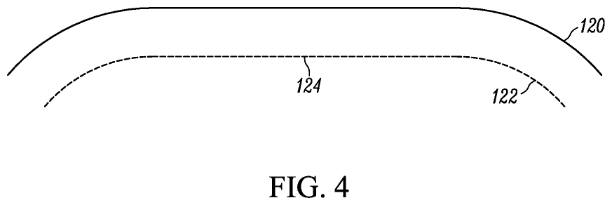

Referring finally to FIG. 4, which is a top view of a preferred embodiment, the windshield 120 is curved. A parallax barrier 122 for such a windshield is also curved. Each slit 124 in the curved parallax barrier 122 and the separation distance from the windshield 120 is selected to allow a driver to see images in front of the vehicle and along its sides but not images projected onto the windshield by a display device. Similarly, the slits allow a passenger to see images projected onto the windshield 120 but not see images in front of the vehicle so long as such images are being projected.

The foregoing description is for purposes of illustration only. The true scope of the invention is set forth in the claims.

What is claimed is:

1. A multiuser parallax display for a motor vehicle having a driver, a passenger and a windshield, the windshield having an interior side and an exterior side, the multiuser parallax display comprising:
a parallax barrier laterally separated from the interior side of the windshield by a predetermined distance, the parallax barrier having a plurality of slits, each slit having a predetermined width, each slit of the plurality of slits having a predetermined space between it and adjacent slits, the predetermined space between slits determining the predetermined distance by which the parallax barrier is laterally separated from the interior side of the windshield; and
a display device configured to project an image onto the interior side of the windshield;
wherein the parallax barrier is configured to allow the driver to see objects in front of the motor vehicle through the windshield and configured to allow the passenger to see images projected onto the interior side of the windshield;
wherein the driver cannot see images projected by the display device and wherein the passenger cannot see objects in front of the motor vehicle while the display device is projecting an image onto the interior side of the windshield.

2. The multiuser parallax display of claim 1, wherein the display device is a video projector configured to project series of visible image onto the interior side of the windshield.

3. The multiuser parallax display of claim 1, wherein the windshield and parallax barrier are curved.
